(19) United States
(12) Patent Application Publication
(10) Pub. No.: US 2017/0361683 A1
(43) Pub. Date: Dec. 21, 2017

(54) MOTORIZED DUCT OUTLET FOR HVAC SYSTEM

(71) Applicant: GM Global Technology Operations LLC, Detroit, MI (US)

(72) Inventors: Gerard A. Brinas, Sterling Heights, MI (US); Marc Florian, Southfield, MI (US)

(21) Appl. No.: 15/187,820

(22) Filed: Jun. 21, 2016

(51) Int. Cl. B60H 1/34; B60H 1/00

(52) U.S. Cl. CPC B60H 1/3428; B60H 1/3421; B60H 1/00871; B60H 1/00985; B60H 2001/3471

(57) ABSTRACT

A ventilation system for a vehicle includes a duct with an outlet. A housing is in fluid communication with the outlet. A vane is disposed within the housing. The vane has a first pivot axis and a second pivot axis. A first electric motor is configured to pivot the vane relative to the first pivot axis, and a second electric motor is configured to pivot the vane relative to the second pivot axis. A controller is configured to control the first electric motor to pivot the vane relative to the first pivot axis and to control the second electric motor to pivot the vane relative to the second pivot axis.

### TECHNICAL FIELD

The present disclosure relates generally to an automotive vehicle ventilation system, and more particularly to an outlet having movable vanes.

### INTRODUCTION

For heating and cooling, automotive vehicles are generally provided with a ventilation system with air vents opening into the vehicle cabin. Such vents are typically arranged in a front dash of the vehicles, and in some vehicles may also be arranged in other locations of the vehicle cabin.

The vents are generally provided with a lever or control knob arranged to adjust the direction of airflow from the vent, e.g. by adjusting angle orientation of vanes in the vent.

### SUMMARY

An automotive vehicle according to the present disclosure includes an interior cabin. The vehicle further includes a climate control system including a duct. The duct has an outlet opening into the interior cabin. The vehicle also includes a housing coupled to the outlet. A vane is disposed within the housing. The vane has a first pivot axis and a second pivot axis. The vehicle includes a first electric motor and a second electric motor. The first electric motor is configured to pivot the vane relative to the first pivot axis, and the second electric motor is configured to pivot the vane relative to the second pivot axis.

According to various embodiments, the second electric motor is configured to pivot the housing about the second pivot axis relative to the outlet. The housing may be generally cylindrical in shape.

According to various embodiments, the vehicle further includes a second vane and a linkage coupling the first vane and the second vane. The linkage is configured to pivot the second vane in response to the vane pivoting relative to the first pivot axis.

According to various embodiments, the vehicle additionally includes a worm gear, a vane pivot arm coupled to the vane, and a swing arm. The swing arm has a first end and a second end. The first end is provided with a plurality of teeth. The first electric motor is drivingly coupled to the worm gear. The worm gear is in meshing engagement with the plurality of teeth to pivot the swing arm. The second end of the swing arm is drivingly coupled to the vane pivot arm to pivot the vane.

According to various embodiments, the vehicle additionally includes a user input interface and a controller. The controller is configured to control the first electric motor and the second electric motor in response to a user input to the user interface. The vehicle may additionally include a temperature sensor, and the controller may be further configured to control the first electric motor and the second electric motor in response to a measured temperature from the temperature sensor. The vane may have a default position relative to the first pivot axis and the second pivot axis, and the controller may be further configured to, in response to a user input, control the first electric motor and the second electric motor to pivot the vane to the default position.

An outlet assembly for an HVAC duct in a vehicle according to the present disclosure includes a housing. The housing is configured to pivotably couple to an outlet of a duct. The outlet assembly additionally includes a vane disposed within the housing. The vane is pivotably coupled to the housing. The outlet assembly additionally includes a first electric motor and a second electric motor. The first electric motor is configured to pivot the vane relative to a first pivot axis, and the second electric motor is configured to pivot the vane relative to a second pivot axis.

According to various embodiments, the second electric motor is configured to pivot the housing about the second pivot axis relative to an outlet. The housing may be cylindrical in shape.

According to various embodiments, the outlet assembly additionally includes a second vane and a linkage coupling the first vane and the second vane. The linkage is configured to pivot the second vane in response to the vane pivoting relative to the first pivot axis.

According to various embodiments, the outlet assembly additionally includes a worm gear, a vane pivot arm coupled to the vane, and a swing arm. The swing arm has a first end and a second end. The first end is provided with a plurality of teeth. The first electric motor is drivingly coupled to the worm gear. The worm gear is in meshing engagement with the plurality of teeth to pivot the swing arm. The second end of the swing arm is drivingly coupled to the vane pivot arm to pivot the vane.

A ventilation system for a vehicle according to the present disclosure includes a duct with an outlet. A housing is in fluid communication with the outlet. A vane is disposed within the housing. The vane has a first pivot axis and a second pivot axis. A first electric motor is configured to pivot the vane relative to the first pivot axis, and a second electric motor is configured to pivot the vane relative to the second pivot axis. A controller is configured to control the first electric motor to pivot the vane relative to the first pivot axis and to control the second electric motor to pivot the vane relative to the second pivot axis.

According to various embodiments, the second electric motor is configured to pivot the housing relative to the second pivot axis.

According to various embodiments, the ventilation system additionally includes a second vane and a linkage coupling the second vane and the vane. The linkage is configured to pivot the second vane in response to the vane pivoting relative to the first pivot axis.

According to various embodiments, the ventilation system additionally includes a worm gear, a vane pivot arm coupled to the vane, and a swing arm. The swing arm has a first end and a second end. The first end is provided with a plurality of teeth. The first electric motor is drivingly coupled to the worm gear. The worm gear is in meshing engagement with the plurality of teeth to pivot the swing arm. The second end of the swing arm is drivingly coupled to the vane pivot arm to pivot the vane.

According to various embodiments, the controller is further configured to control the first electric motor and the second electric motor in response to at least one measured temperature.

According to various embodiments, the vane has a default position relative to the first pivot axis and the second pivot axis, and the controller is further configured to, in response to a user input, control the first electric motor and the second electric motor to pivot the vane to the default position.

According to various embodiments, the duct has a second outlet. In such embodiments, the ventilation system additionally includes a second housing in fluid communication with the second outlet. A second vane is disposed within the second housing. The second vane has a third pivot axis and a fourth pivot axis. The ventilation system additionally includes a third electric motor and a fourth electric motor. The third electric motor is configured to pivot the second vane relative to the third pivot axis. The fourth electric motor is configured to pivot the second vane relative to the fourth pivot axis. The controller is further configured to control the third electric motor to pivot the second vane relative to the third pivot axis and to control the fourth electric motor to pivot the vane relative to the fourth pivot axis.

Embodiments according to the present disclosure provide a number of advantages. For example, the present disclosure provides a vent assembly for a ventilation system which may be controlled remotely, and moreover may provide various automated vent control functions, thus increasing customer satisfaction. Moreover, the present disclosure provides a low-profile vent assembly which may more easily be integrated into small packaging spaces.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a view of a vehicle dashboard having a plurality of vents for a ventilation system;

FIG. 2 is a representative vent assembly according to the prior art;

FIG. 3 is an exploded view of a vent assembly according to the present disclosure;

FIGS. 4A-4C illustrate a second mode of operation of a vent assembly according to the present disclosure;

FIGS. 5A-5C illustrate a first mode of operation of a vent assembly according to the present disclosure;

FIG. 6 is an schematic view of a ventilation system for a vehicle according to the present disclosure; and

FIG. 7 illustrates control of a vent assembly according to the present disclosure in flowchart form.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

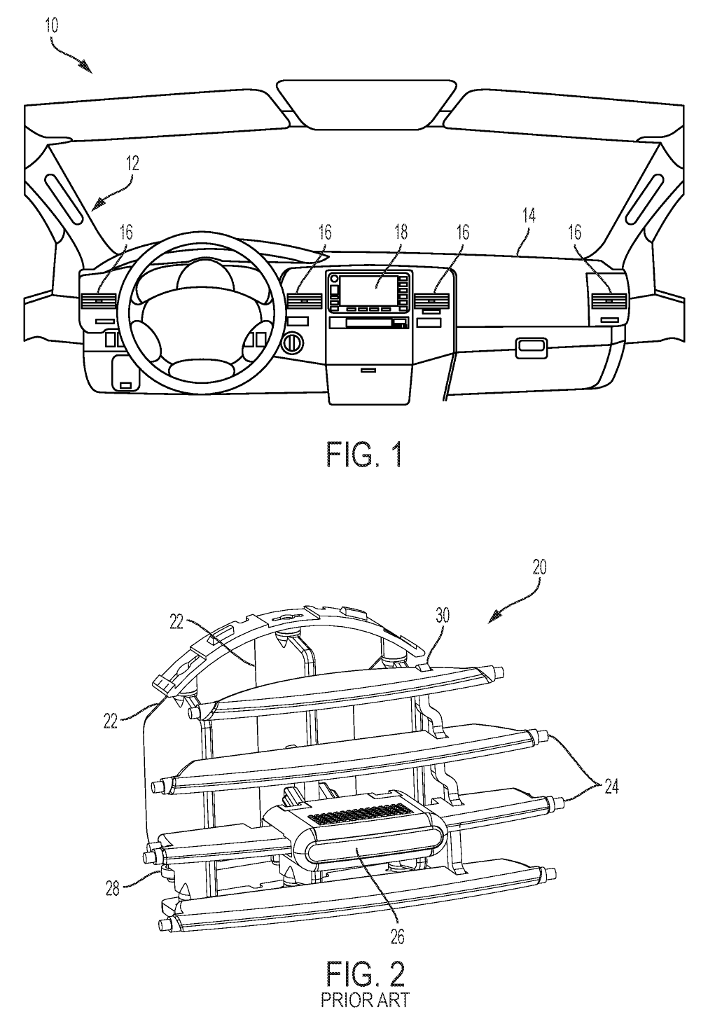

Referring now to FIG. 1, an interior cabin 12 of an exemplary embodiment of a vehicle 10 is illustrated. The interior cabin 12 includes a dashboard 14. A plurality of vent assemblies 16 are provided on the dashboard 14. The vent assemblies 16 are provided with a plurality of adjustable vanes for directing air from a ventilation system to a desired portion of the interior cabin 12.

A multi-function display 18 is also provided on the dashboard 14. The multi-function display is configured to present various information screens to a user and/or provide various control interfaces to a user.

Referring now to FIG. 2, an isometric view of a prior art vent assembly 20 is shown. The vent assembly 20 includes a plurality of vertical vanes 22 and a plurality of horizontal vanes 24 retained within a housing. A knob 26 is provided to adjust the vertical vanes 22 and the horizontal vanes 24. The knob 26 is mechanically coupled to a respective vane of the vertical vanes 22 and to a respective vane of the horizontal vanes 24. The knob 26 may slide relative to the respective horizontal vane 24 in order to pivot the respective vertical vane 22. The vertical vanes 22 are coupled by a first linkage 28, such that the pivoting of the respective vertical vane 22 pivots the plurality of vertical vanes 22. In addition, the knob 26 may pivot in order to pivot the respective horizontal vane 24. The horizontal vanes 24 are coupled by a second linkage 28, such that the pivoting of the respective horizontal vane 24 pivots the plurality of horizontal vanes 24.

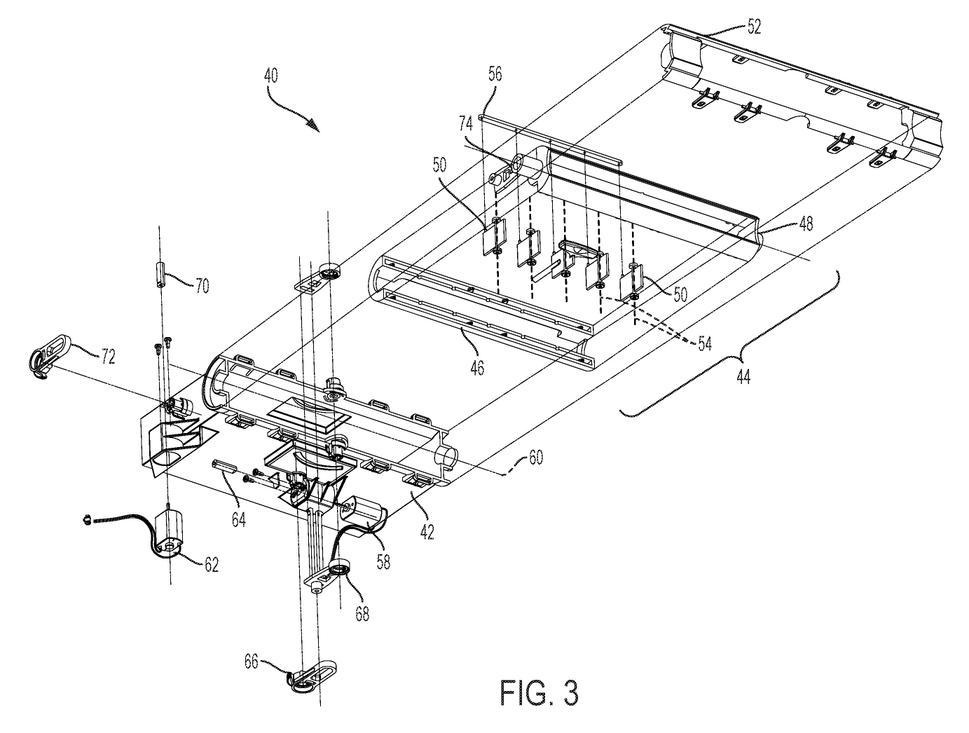

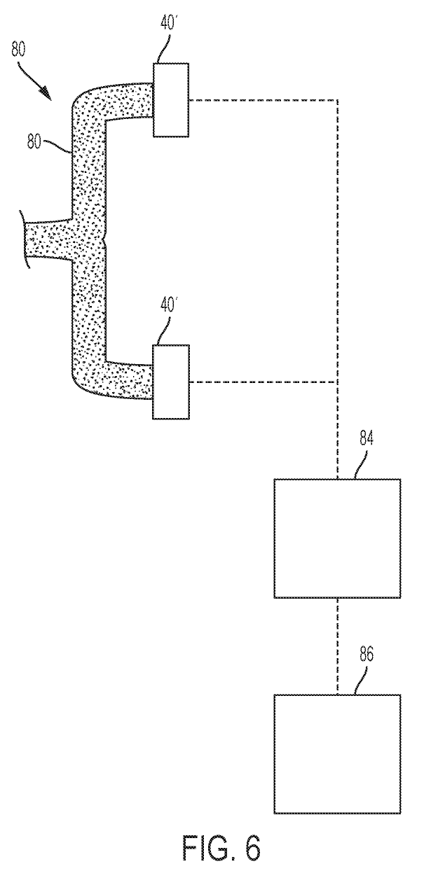

Referring now to FIG. 3, an exploded view of a vent assembly 40 according to the present disclosure is shown. The vent assembly 40 includes a rear housing 42. The rear housing 42 is configured to fixedly couple to an outlet of a duct, as will be discussed below with respect to FIG. 6. The vent assembly 40 additionally includes a cylindrical housing 44 having a first portion 46 and a second portion 48. A plurality of vanes 50 is disposed within the cylindrical housing 44. A trim bezel 52 is coupled to the front of the rear housing 42, and is configured to provide a desired aesthetic impression from the interior of the vehicle cabin.

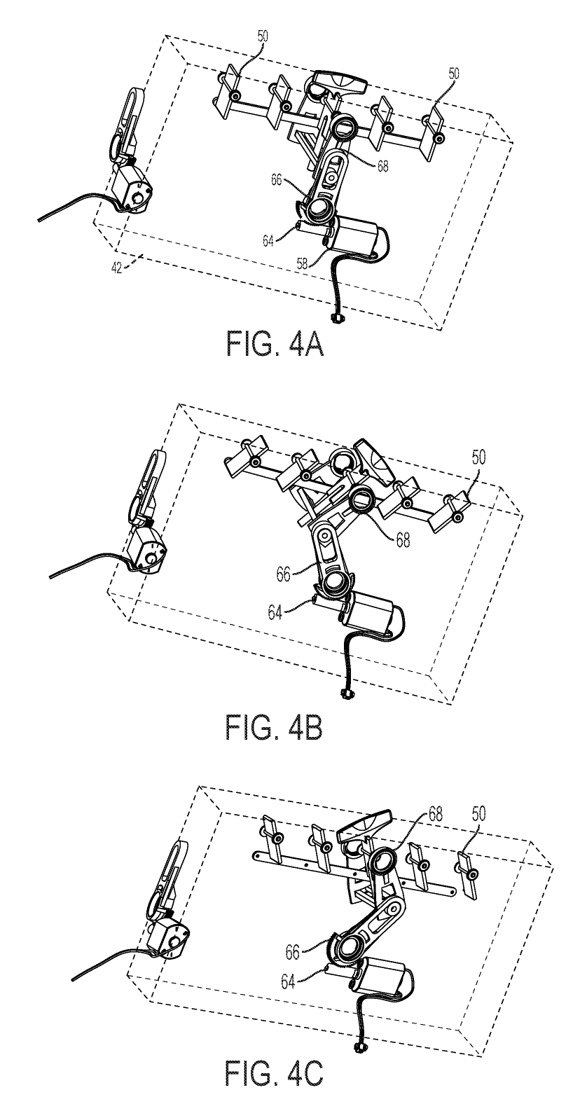

The plurality of vanes 50 are pivotable within the cylindrical housing 44, as will be discussed below with respect to FIGS. 4A-4C. Each vane 50 has a respective vane pivot axis 54. The vane pivot axes 54 are generally parallel with one another. The plurality of vanes 50 are coupled by a vane linkage 56, such that the vanes 50 pivot together about the vane pivot axes 54. A first electric motor 58 is provided to control pivoting of the vanes 50.

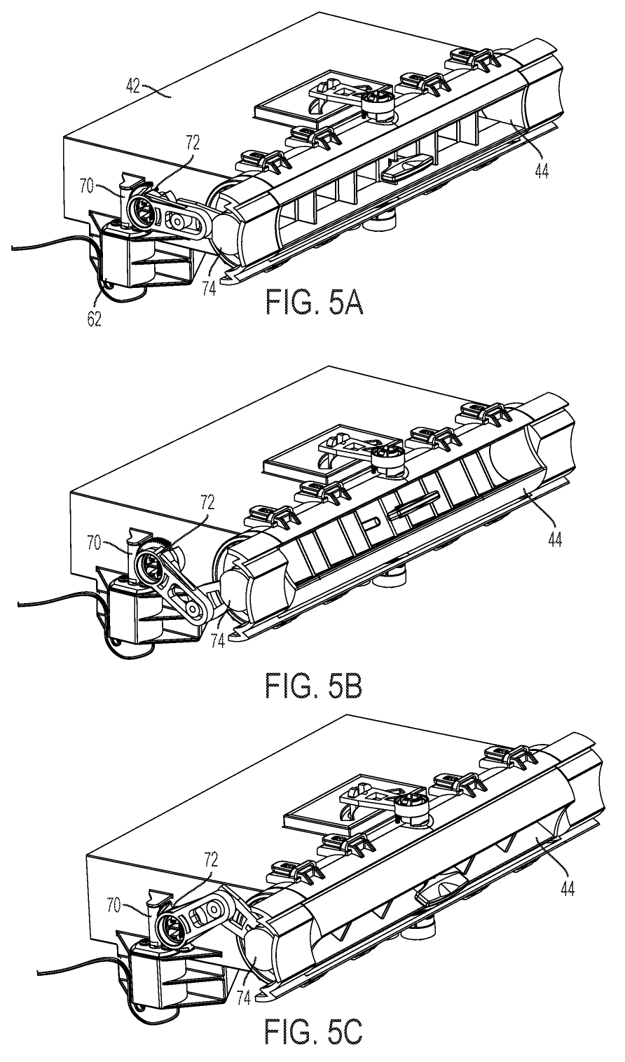

The cylindrical housing 44 is pivotably coupled to the rear housing 42, as will be discussed below with respect to FIGS. 5A-5C. The cylindrical housing 44 has a housing pivot axis 60. A second electric motor 62 is provided to control pivoting of the cylindrical housing 44.

Referring now to FIGS. 4A-4C, a first pivoting mode of operation is shown. In an exemplary embodiment, the vanes 50 have a “neutral” position with the vanes 50 oriented generally parallel with a direction of air flow from the rear housing 42, as illustrated in FIG. 4A. The first electric motor 58 is operable to pivot the vanes 50 in a first direction about the vane pivot axes 54, as illustrated in FIG. 4B, to direct air from the duct in a first direction. The first electric motor 58 is also operable to pivot the vanes 50 in a second direction about the vane pivot axes 54, as illustrated in FIG. 4C, to direct air from the duct in a second direction.

In this exemplary embodiment, the first electric motor 58 is drivingly coupled to a first worm gear 64. The first worm gear 64 is in meshing engagement with teeth an end of a first helical drive gear 66, such that rotation of the first worm gear 64 causes the first helical drive gear 66 to pivot about an axis generally parallel to the vane pivot axes 54. The first helical drive gear 66 is, in turn, slidably and pivotably coupled to a first swing arm 68, such that pivoting of the first helical drive gear 66 causes the first swing arm 68 to pivot about an axis generally parallel to the vane pivot axes 54 in a direction opposite the pivoting of the first helical drive gear 66. The first swing arm 68 is drivingly coupled to a respective vane of the vanes 50, such that pivoting of the first swing arm 68 drives the respective vane in pivoting. The vane linkage 56, in turn, drives the vanes 50 to pivot together about the vane pivoting axes 54.

Referring now to FIGS. 5A-5C, a second pivoting mode of operation is shown. In an exemplary embodiment, the cylindrical housing 44 has a “neutral” position with the cylindrical housing 44 oriented generally parallel with a direction of air flow from the rear housing 42, as illustrated in FIG. 5A. The second electric motor 62 is operable to pivot the cylindrical housing 44 in a first direction about the housing pivot axis 60, as illustrated in FIG. 5B, to direct air from the duct in a first direction. The second electric motor 62 is also operable to pivot the cylindrical housing 44 in a second direction about the housing pivot axis 60, as illustrated in FIG. 5C, to direct air from the duct in a second direction.

In this exemplary embodiment, the second electric motor 58 is drivingly coupled to a second worm gear 70. The second worm gear 70 is in meshing engagement with teeth an end of a second helical drive gear 72, such that rotation of the second worm gear 70 causes the second helical drive gear 72 to pivot about an axis generally parallel to the housing pivot axis 60. The second helical drive gear 72 is, in turn, slidably and pivotably coupled to a second swing arm 74, such that pivoting of the second helical drive gear 72 causes the second swing arm 74 to pivot about an axis generally parallel to the housing pivot axis 60 in a direction opposite the pivoting of the second helical drive gear 72. The second swing arm 74 is drivingly coupled to the cylindrical housing 44, such that pivoting of the second swing arm 74 drives the cylindrical housing 44 in pivoting. Because the vanes 50 are retained within the housing, the vanes 50 are pivoted about the housing pivot axis 60 in conjunction with the cylindrical housing 44.

Advantageously, the embodiment illustrated in FIGS. 3-5, having the cylindrical housing 44 retaining the vanes 50, provides a low-profile vent assembly. Such embodiments provide a smaller footprint in a vehicle dashboard, and may thus alleviate packaging challenges associated with conventional vent designs. Moreover, such embodiments include only one row of vanes 50, thus reducing air flow blockage relative to conventional vent designs having two rows of vanes. However, other configurations are contemplated within the scope of the present disclosure.

Referring now to FIG. 6, a schematic view of a ventilation system 80 for a vehicle according to the present disclosure is illustrated. The ventilation system 80 includes a duct 82. The duct 82 is in fluid communication with at least two vent assemblies 40′. In an exemplary embodiment, each vent assembly 40′ is configured in similar fashion to the vent assembly 40 illustrated in FIGS. 3-5, e.g. including first and second electric motors.

The vent assemblies 40′ are in communication with and/or under the control of at least one controller 84. The controller 84 is configured to control the respective electric motors of the vent assemblies 40′ to pivot the respective vanes of the vent assemblies 40′ about multiple axes.

While depicted as a single unit, the controller 84 and one or more other controllers can collectively be referred to as a “controller.” The controller 84 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 84 is in communication with a user interface 86. According to various embodiments, the user interface may include a physical control, e.g. knobs or switches, and/or a touchscreen interface. The controller 84 is configured to control the respective electric motors of the vent assemblies 40′ in response to at least one user input to the user interface 86. Advantageously, the user interface 86 does not need to be positioned proximate any of the vent assemblies 40′, and may be located remotely from the vent assemblies 40′ if desirable for aesthetic or functional considerations. The user interface 86 may be, for example, integrated into a central multi-function display in a vehicle dashboard.

According to an exemplary embodiment, the user interface 86 may receive a first user input for selecting a desired vent assembly 40′ and a second user input for selecting a desired direction of pivoting. In response to the first and second inputs, the controller 84 controls the vent assembly 40′ associated with the first user input in the direction associated with the second user input. In some embodiments, the controller 84 may control multiple vent assemblies 40′ to pivot in unison. It should be understood that pivoting a vent assembly refers to control of the respective electric motors associated with a vent assembly 40′ to pivot the cylindrical housing and/or vanes in a desired direction.

According to another exemplary embodiment, the user interface 86 may receive a user input for selecting at least one stored vent orientation. In response to a user selection of the stored vent orientation, the controller 84 automatically controls the respective electric motors of the vent assemblies 40′ to pivot the vent assemblies 40′ to the stored orientation. According to various embodiments, the stored vent orientation may be provided on a per-vent basis and/or as a set of stored orientations for all vent assemblies 40′ of the ventilation system 80. According to various embodiments, the stored vent orientation may be predefined, e.g. by a manufacturer, or may be defined by a user of the vehicle.

According to an additional exemplary embodiment, the user interface 86 may receive a user input for selecting a desired temperature. In response to a user selection of the desired temperature and in response to temperature readings from at least one temperatures sensor disposed in the cabin 12, the controller 84 automatically controls the respective electric motors of the vent assemblies 40′ to pivot the vent assemblies 40′ to attain a consistent temperature throughout the cabin 12. As an example, the controller 84 may pivot the vent assemblies 40′ to direct increased air flow toward a region of the cabin 12 where a temperature reading is relatively far from the desired temperature.

According to a further exemplary embodiment, the user interface 86 may receive a user input for selecting an oscillation mode. In response to a user selection of the oscillation mode, the controller 84 automatically controls the respective electric motors of the vent assemblies 40′ to pivot the vent assemblies 40′ in a repeating pattern. The pattern may include oscillation about one axis, e.g. in a back-and-forth pattern, or about multiple axes, e.g. in a circular pattern.

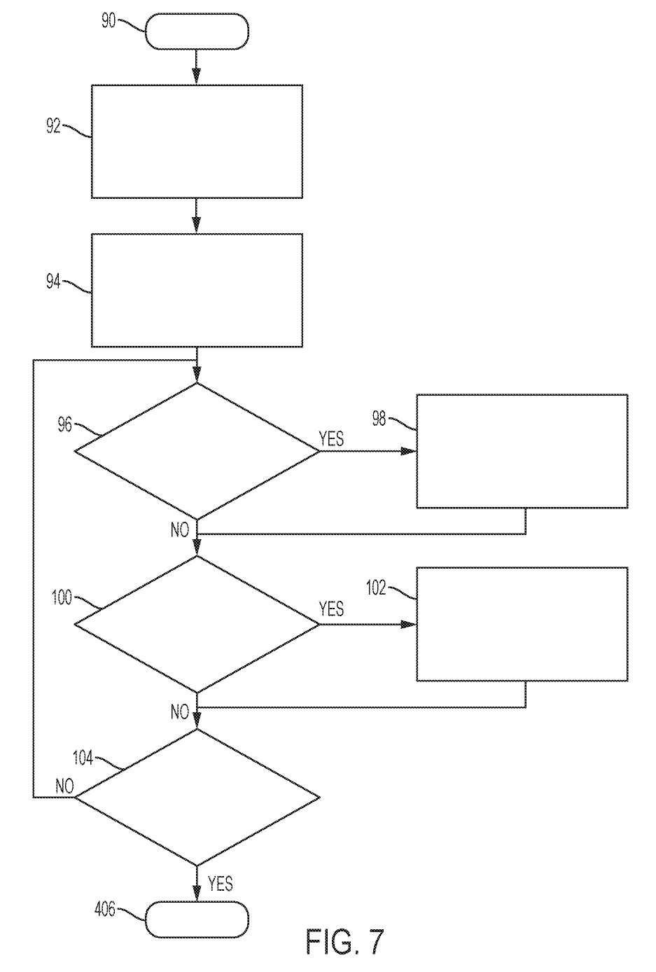

Referring now to FIG. 7, a method of controlling a vent assembly according to the present disclosure is illustrated in flowchart form.

According to another exemplary embodiment, the user interface 86 may receive a user input for selecting at least one venting mode. The venting modes may include, but are not limited to, a vent oscillation mode and a max driver air mode. In the vent oscillation mode, at least one respective electric motor of the vent assemblies 40′ is automatically controlled to pivot the vent assemblies 40′ in an oscillating pattern. In the max driver air mode, at least one respective vent assembly 40′ proximate a driver seat is automatically pivoted to direct air toward the driver seat, and other respective vent assemblies 40′ are automatically controlled to restrict air flow, e.g. by pivoting respective vanes to be generally perpendicular to a direction of air flow. Thus, the flow of air through the respective vane assemblies 40′ proximate the driver seat is maximized.

According to another exemplary embodiment, the controller 64 is configured to, in response to a key-on and/or key-off event, automatically control the respective electric motors of the vent assemblies 40′ to pivot the vent assemblies 40′ to a default position. The default position may correspond to the vanes of the vent assemblies 40′ being in a neutral position, e.g. oriented generally parallel to airflow, and the cylindrical housings of the vent assemblies 40′ being in a neutral position, e.g. oriented generally parallel to airflow. The default position may be defined for aesthetic and/or functional reasons. By controlling the vent assemblies 40′ to a default position in response to a key-on or key-off event, a user may be presented with a consistent experience upon beginning each drive cycle.

Referring now to FIG. 7, a method of controlling a ventilation system according to the present disclosure is illustrated in flowchart form. The method begins at block 90. A key-on event is received, as illustrated at block 92. The key-on event may include a key being used to manually start the vehicle, or a remote start of the vehicle. Motors are then controlled to pivot vent assemblies in the vehicle to default positions, as illustrated at block 94.

A determination is made of whether a specific vent control mode has been selected, e.g. via an operator input at a user interface, as illustrated at operation 96. If the determination of operation 96 is positive, motors are controlled to pivot vent assemblies according to the selected mode, as illustrated at block 98. Control then proceeds to operation 100. If the determination of operation 96 is negative, control proceeds directly to operation 100.

A determination is made of whether a user control input has been received, e.g. via a user interface, as illustrated at operation 100. If the determination of operation 96 is positive, motors are controlled to pivot vent assemblies according to the user input, as illustrated at block 102. Control then proceeds to operation 104. If the determination of operation 100 is negative, control proceeds directly to operation 104.

At operation 104, a determination is made of whether a key-off event has been received. If the determination of operation 104 is negative, control returns to operation 96. If the determination of operation 104 is positive, the algorithm ends at block 106.

As may be seen, the present disclosure provides a vent assembly for a ventilation system which may be controlled remotely. Moreover, embodiments according to the present disclosure may provide various automated vent control functions, thus increasing customer satisfaction.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
an interior cabin;
a climate control system including a duct, the duct having an outlet into the interior cabin;
an outlet housing coupled to the outlet;
a vane disposed within the housing, the vane having a first pivot axis and a second pivot axis;
a first electric motor configured to pivot the vane relative to the first pivot axis; and
a second electric motor configured to pivot the vane relative to the second pivot axis.

2. The vehicle of claim 1, wherein the second electric motor is configured to pivot the housing about the second pivot axis relative to the outlet.

3. The vehicle of claim 2, wherein the housing is generally cylindrical in shape.

4. The vehicle of claim 1, further comprising a second vane and a linkage coupling the vane to the second vane, the linkage being configured to pivot the second vane in response to the vane pivoting relative to the first pivot axis.

5. The vehicle of claim 1, further comprising a worm gear, a vane pivot arm coupled to the vane, and a swing arm having a first end and a second end, the first end being provided with a plurality of teeth, the first electric motor being drivingly coupled to the worm gear, the worm gear being in meshing engagement with the plurality of teeth to drive the swing arm, the second end of the swing arm being drivingly coupled to the vane pivot arm to pivot the vane.

6. The vehicle of claim 1, further comprising a user input interface and a controller, the controller being programmed to operate the first electric motor and the second electric motor in response to a user input to the user interface.

7. The vehicle of claim 6, further comprising a temperature sensor, wherein the controller is further configured to control the first electric motor and the second electric motor in response to a measured temperature from the temperature sensor.

8. The vehicle of claim 6, wherein the vane has a default position relative to the first pivot axis and the second pivot axis, and wherein the controller is further programmed to, in response to a user input, operate the first electric motor and the second electric motor to pivot the vane to the default position.

9. An outlet assembly for a ventilation duct in a vehicle, the outlet assembly comprising:
a housing configured to pivotably couple to an outlet of a duct;
a vane disposed within the housing and pivotably coupled to the housing;
a first electric motor configured to pivot the vane relative to a first pivot axis; and
a second electric motor configured to pivot the vane relative to a second pivot axis.

10. The outlet assembly of claim 9, wherein the second electric motor is configured to pivot the housing about the second pivot axis relative to an outlet.

11. The outlet assembly of claim 10, wherein the housing is cylindrical in shape.

12. The outlet assembly of claim 9, further comprising a second vane and a linkage coupling the vane and the second vane, the linkage being configured to pivot the second vane in response to the vane pivoting relative to the first pivot axis.

13. The outlet assembly of claim 9, further comprising a worm gear, a vane pivot arm coupled to the vane, and a swing arm having a first end and a second end, the first end being provided with a plurality of teeth, the first electric motor being drivingly coupled to the worm gear, the worm gear being in meshing engagement with the plurality of teeth to actuate the swing arm, the second end of the swing arm being drivingly coupled to the vane pivot arm to pivot the vane.

14. A ventilation system for a vehicle, comprising:
a duct having an outlet;
a housing in fluid communication with the outlet;
a vane disposed within the housing, the vane having a first pivot axis and a second pivot axis;
a first electric motor configured to pivot the vane relative to the first pivot axis;
a second electric motor configured to pivot the vane relative to the second pivot axis; and
a controller programmed to operate the first electric motor to pivot the vane relative to the first pivot axis and to control the second electric motor to pivot the vane relative to the second pivot axis.

15. The ventilation system of claim 14, wherein the second electric motor is configured to pivot the housing relative to the second pivot axis.

16. The ventilation system of claim 14, further comprising a second vane and a linkage coupling the second vane to the vane, the linkage being configured to pivot the second vane in response to the vane pivoting relative to the first pivot axis.

17. The ventilation system of claim 14, further comprising a worm gear, a vane pivot arm coupled to the vane, and a swing arm having a first end and a second end, the first end being provided with a plurality of teeth, the first electric motor being drivingly coupled to the worm gear, the worm gear being in meshing engagement with the plurality of teeth to pivot the swing arm, the second end of the swing arm being drivingly coupled to the vane pivot arm to pivot the vane.

18. The ventilation system of claim 14, wherein the controller is further programmed to operate the first electric motor and the second electric motor in response to at least one measured temperature.

19. The ventilation system of claim 14, wherein the vane has a default position relative to the first pivot axis and the second pivot axis, and wherein the controller is further programmed to, in response to a user input, operate the first electric motor and the second electric motor to pivot the vane to the default position.

20. The ventilation system of claim 14, wherein the duct has a second outlet, the ventilation system further comprising:
a second housing in fluid communication with the second outlet;
a second vane disposed within the second housing, the second vane having a third pivot axis and a fourth pivot axis;
a third electric motor configured to pivot the second vane relative to the third pivot axis; and
a fourth electric motor configured to pivot the second vane relative to the fourth pivot axis;
wherein the controller is further programmed to operate the third electric motor to pivot the second vane relative to the third pivot axis and to control the fourth electric motor to pivot the vane relative to the fourth pivot axis.
